(19) United States
(12) Patent Application Publication
(10) Pub. No.: US 2002/0133426 A1
(43) Pub. Date: Sep. 19, 2002

(54) Method and apparatus for promoting a product

(76) Inventors: Jay S. Walker, Ridgefield, CT (US); Jose A. Suarez, Fairfield, CT (US); Andrew S. Van Luchene, New York, NY (US); Stephen C. Tulley, Fairfield, CT (US); Dean P. Alderucci, Stamford, CT (US)

Correspondence Address: WALKER DIGITAL, FIVE HIGH RIDGE PARK, STAMFORD, CT, 06905, US

(21) Appl. No.: 10/100,684

(22) Filed: Mar. 15, 2002

Related U.S. Application Data
(60) Provisional application No. 60/276,503, filed on Mar. 15, 2001.

(51) Int. Cl. G06F 17/60

(52) U.S. Cl. 705/26

(57) ABSTRACT

Systems and methods are provided for establishing online a buyer price for a first plurality of products. The buyer price being lower than a retail price of the first plurality of products, the first plurality of products to be picked up during a subsequent transaction at a retailer. Thereafter, a second plurality of products which the buyer has actually received during the subsequent transaction is determined. Thereafter, a promotional offer is output during a subsequent interaction with the customer.

### CROSS-REFERENCE TO RELATED APPLICATIONS

This application claims the benefit of provisional patent application Serial No. 60/276,503, filed Mar. 15, 2001, entitled “SYSTEMS AND METHODS FOR PRESENTING PROMOTIONAL OFFERS BASED ON A DIFFERENTIAL BETWEEN A SET OF PRICED PRODUCTS AND A SET OF ACQUIRED PRODUCTS”, the content of which is incorporated by reference herein for all purposes.

This application is related to the following co-pending U.S. Patent Applications:

U.S. patent application Ser. No. ______ (attorney docket no. 00-111) entitled “PROCESS AND PRODUCT FOR PROMOTING A PRODUCT”, filed concurrently herewith;

U.S. patent application Ser. No. ______ (attorney docket no. 00-112) entitled “PROCESS AND PRODUCT FOR ENFORCING PURCHASE AGREEMENTS”, filed concurrently herewith;

U.S. patent application Ser. No. ______ (attorney docket no. 00-113) entitled “METHOD AND APPARATUS FOR PRODUCT DISPLAY”, filed concurrently herewith;

U.S. patent application Ser. No. 09/609,598, entitled “SYSTEMS AND METHODS WHEREIN A BUYER PURCHASES PRODUCTS IN A PLURALITY OF PRODUCT CATEGORIES”, filed Jun. 29, 2000;

U.S. patent application Ser. No. 08/889503, entitled “SYSTEMS AND METHODS WHEREIN A BUYER PURCHASES A PRODUCT AT A FIRST PRICE AND ACQUIRES THE PRODUCT FROM A MERCHANT THAT OFFERS THE PRODUCT FOR SALE AT A SECOND PRICE”, filed Jul. 8, 1997 and issued as U.S. Pat. No. 6,249,772 on Jun. 19, 2001;

U.S. patent application Ser. No. 09/591594, entitled “SYSTEMS AND METHODS WHEREIN A BUYER PURCHASES A PRODUCT AT A FIRST PRICE AND PHYSICALLY ACQUIRES THE PRODUCT AT A LOCATION ASSOCIATED WITH A MERCHANT THAT OFFERS THE PRODUCT FOR SALE AT A SECOND PRICE”, filed Jun. 29, 2000;

U.S. patent application Ser. No. 09/348566, entitled “SETTLEMENT SYSTEMS AND METHODS WHEREIN A BUYER TAKES POSSESSION AT A RETAILER OF A PRODUCT PURCHASED USING A COMMUNICATION NETWORK”, filed Jul. 7, 1999;

U.S. patent application Ser. No. 09/388723, entitled “REDEMPTION SYSTEMS AND METHODS WHEREIN A BUYER TAKES POSSESSION AT A RETAILER OF A PRODUCT PURCHASED USING A COMMUNICATION NETWORK”, filed Sep. 2, 1999;

U.S. patent application Ser. No. 09/337906, entitled “PURCHASING SYSTEMS AND METHODS WHEREIN A BUYER TAKES POSSESSION AT A RETAILER OF A PRODUCT PURCHASED USING A COMMUNICATION NETWORK”, filed Jun. 22, 1999;

U.S. patent application Ser. No. 09/370291, entitled “SUPPLEMENTAL OFFERS WHEREIN A BUYER TAKES POSSESSION AT A RETAILER OF A PRIMARY PRODUCT PURCHASED THROUGH A PURCHASING SYSTEM”, filed Aug. 9, 1999;

U.S. patent application Ser. No. 09/412930, entitled “METHODS AND APPARATUS WHEREIN A BUYER ARRANGES TO PURCHASE A FIRST PRODUCT USING A COMMUNICATION NETWORK AND SUBSEQUENTLY TAKES POSSESSION OF A SUBSTITUTE PRODUCT AT A RETAILER”, filed Oct. 5, 1999; and

U.S. patent application Ser. No. 09/540035, entitled “RETAIL SYSTEM FOR SELLING PRODUCTS BASED ON A FLEXIBLE PRODUCT DESCRIPTION”, filed Mar. 31, 2000.

The content of each of the above is incorporated by reference herein for all purposes.

### BACKGROUND OF THE INVENTION

A customer may establish online a buyer price for one or more products, and then pick up those products during a subsequent transaction at a retailer. In return for establishing a buyer price online, the customer receives or is entitled to receive a benefit such as a rebate or discounted price on the product(s).

Many times, the set of products for which a buyer price is established online differs from the set of products picked up at the retailer.

Few systems exist for recognizing this difference.

### BRIEF DESCRIPTION OF THE DRAWINGS

FIG. 1A is a block diagram of an embodiment of a system consistent with the present invention;

FIG. 1B is a block diagram of another embodiment of a system consistent with the present invention;

FIG. 1C is a block diagram of another embodiment of a system consistent with the present invention;

FIG. 2 is a block diagram of one embodiment of a controller;

FIG. 3 is a table illustrating an exemplary data structure of a customer database;

FIG. 4 is a table illustrating an exemplary data structure of a product database;

FIG. 5 is a table illustrating an exemplary data structure of a proposed transaction database;

FIG. 6 is a table illustrating an exemplary data structure of an actual transaction database;

FIG. 7 is a table illustrating an exemplary data structure of a promotional offer database;

FIGS. 8A and 8B comprise a flow diagram illustrating an exemplary process according to an embodiment of the present invention;

### DETAILED DESCRIPTION OF THE INVENTION

Applicants have recognized that, in some situations, it can be advantageous to employ information regarding products for which a buyer price has been established online.

Applicants have also recognized that, in some situations, it can be advantageous to employ information regarding the difference between (i) products for which a buyer price has been established online; and (ii) products actually received.

Applicants have also recognized that, in some situations, it can be advantageous to minimize the difference between products priced online and products actually received.

Applicants have recognized that one of many possible use of such information is to output offers which are based on such information.

According to an embodiment of the present invention, a product may be priced by way of receiving, from a customer, information defining one or more group(s) of comparable products the consumer is willing to purchase from, the information further including a price the customer is willing to pay. The buyer-defined price may be provided in exchange for individual products from within the group, or for the group itself.

For example, the on-line pricing system may transmit a redemption code to the customer device, entitling the customer to take delivery of one or more product(s) from a retailer local to the customer.

Upon taking delivery of the previously priced product(s), the customer device may communicate information related to the product(s) (e.g. one or more product identifier(s)) to the applicable retailer system. According to some embodiments of the present invention, rather than providing information related to the specific products having been taken delivery of, the customer or customer device may simply provide the previously received redemption code to the retailer system.

A detailed discussion of manners in which a redemption code may be assigned, issued and redeemed, as well as other methods related to the process of establishing a price for products and then acquiring products from a retailer, is provided in the following:

U.S. patent application Ser. No. 09/609,598, entitled “SYSTEMS AND METHODS WHEREIN A BUYER PURCHASES PRODUCTS IN A PLURALITY OF PRODUCT CATEGORIES”, filed Jun. 29, 2000;

U.S. patent application Ser. No. 08/889503, entitled “SYSTEMS AND METHODS WHEREIN A BUYER PURCHASES A PRODUCT AT A FIRST PRICE AND ACQUIRES THE PRODUCT FROM A MERCHANT THAT OFFERS THE PRODUCT FOR SALE AT A SECOND PRICE”, filed Jul. 8, 1997 and issued as U.S. Pat. No. 6,249,772 on Jun. 19, 2001;

U.S. patent application Ser. No. 09/591594, entitled “SYSTEMS AND METHODS WHEREIN A BUYER PURCHASES A PRODUCT AT A FIRST PRICE AND PHYSICALLY ACQUIRES THE PRODUCT AT A LOCATION ASSOCIATED WITH A MERCHANT THAT OFFERS THE PRODUCT FOR SALE AT A SECOND PRICE”, filed Jun. 29, 2000;

U.S. patent application Ser. No. 09/348566, entitled “SETTLEMENT SYSTEMS AND METHODS WHEREIN A BUYER TAKES POSSESSION AT A RETAILER OF A PRODUCT PURCHASED USING A COMMUNICATION NETWORK”, filed Jul. 7, 1999;

U.S. patent application Ser. No. 09/388723, entitled “REDEMPTION SYSTEMS AND METHODS WHEREIN A BUYER TAKES POSSESSION AT A RETAILER OF A PRODUCT PURCHASED USING A COMMUNICATION NETWORK”, filed Sep. 2, 1999;

U.S. patent application Ser. No. 09/337906, entitled “PURCHASING SYSTEMS AND METHODS WHEREIN A BUYER TAKES POSSESSION AT A RETAILER OF A PRODUCT PURCHASED USING A COMMUNICATION NETWORK”, filed Jun. 22, 1999;

U.S. patent application Ser. No. 09/370291, entitled “SUPPLEMENTAL OFFERS WHEREIN A BUYER TAKES POSSESSION AT A RETAILER OF A PRIMARY PRODUCT PURCHASED THROUGH A PURCHASING SYSTEM”, filed Aug. 9, 1999;

U.S. patent application Ser. No. 09/412930, entitled “METHODS AND APPARATUS WHEREIN A BUYER ARRANGES TO PURCHASE A FIRST PRODUCT USING A COMMUNICATION NETWORK AND SUBSEQUENTLY TAKES POSSESSION OF A SUBSTITUTE PRODUCT AT A RETAILER”, filed Oct. 5, 1999; and

U.S. patent application Ser. No. 09/540035, entitled “RETAIL SYSTEM FOR SELLING PRODUCTS BASED ON A FLEXIBLE PRODUCT DESCRIPTION”, filed Mar. 31, 2000.

According to another embodiment of the invention, products may be priced by way of receiving, from a consumer, information defining one or more types or categories of comparable products the consumer is willing to purchase from. Thereafter, the system may select one or more products from the group as well as arrange for the consumer to receive an offer for a rebate or other benefit based on the selected product(s).

By way of example only, a consumer may price a first set of products on-line (e.g. products A, B and C) and subsequently take delivery of a second set of products from a local merchant (e.g., products A, B, C, D and E). During a subsequent on-line pricing process, the non-inclusive products (products D and E) may be the subject of, or may otherwise influence, one or more promotional offer(s) to be presented to the consumer.

The differential may be determined based on information received by the pricing system (i) from the consumer during a pricing negotiation and (ii) from a retailer from which the consumer subsequently takes delivery of the previously priced products (e.g. in the form of a transaction log). Thereafter, the pricing system may correlate the consumer to the determined differential and present promotional offers to the consumer based on the differential. As discussed above promotional offers may take several forms including product subscription enrollment offers, upsell offers, and/or discount pricing offers.

According to one embodiment of the present system, the differential between a set of products priced on-line and a set of products subsequently taken delivery of from a retail store may be used to effectuate product placement at the pricing system.

By acknowledging the differential between a set of products priced on-line and a set of products subsequently acquired from a physical retailer, an Internet-based pricing system may be better suited to select and present promotional offers based on the differential, thereby capturing higher pricing and sales volume.

Further, the nature of the promotional offer(s) presented to consumers may be such that consumers may realize certain benefits by accepting the offer(s). For example, promotional offers may be structured in such a way so as to entitle a consumer to a reduced price on certain product(s) in exchange for the consumer agreeing to purchase an agreed-upon quantity of the product(s) over an agreed-upon duration of time (i.e. a product subscription agreement).

These and other embodiments are described herein.

System

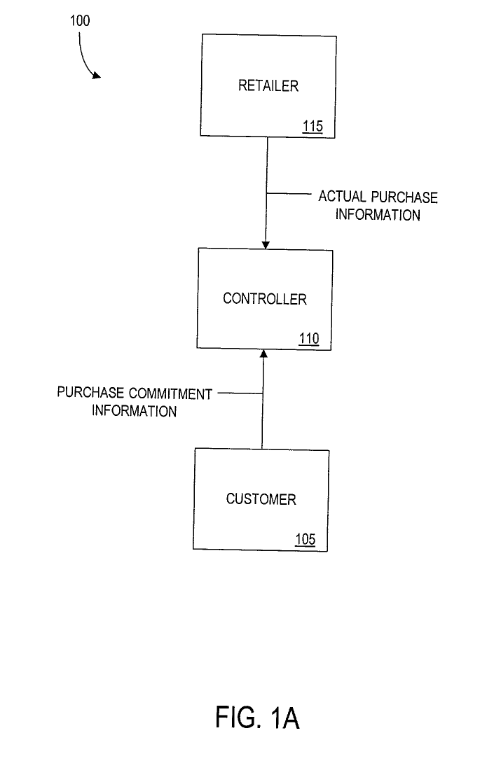

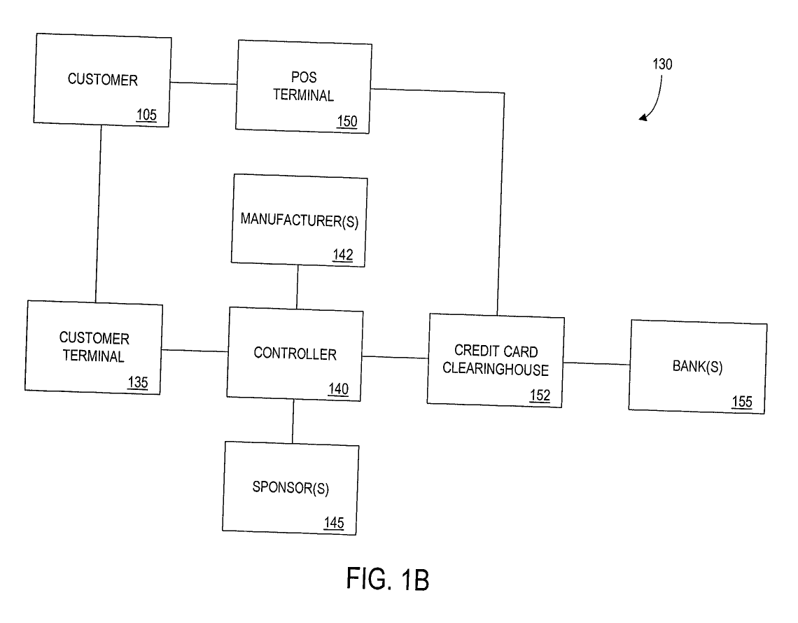

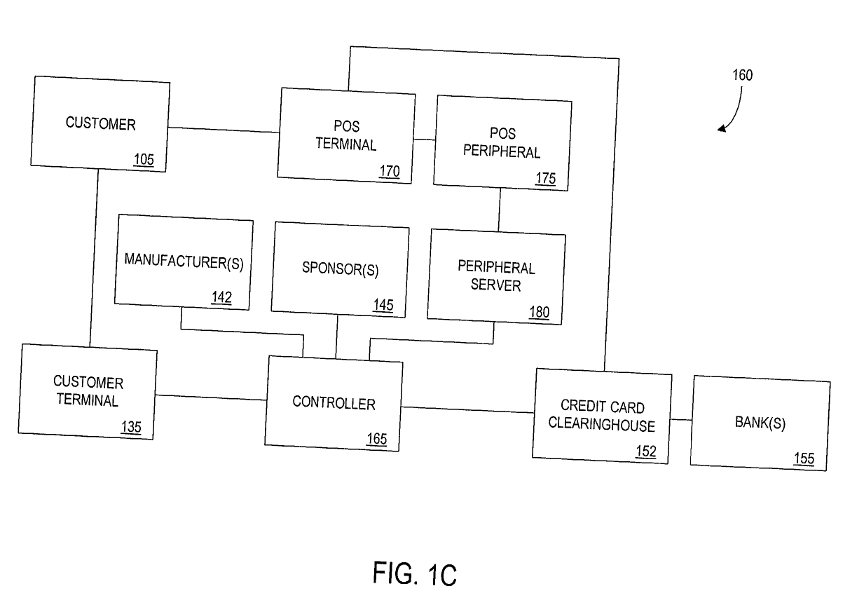

Referring now to FIG. 1, an apparatus 100 according to an embodiment of the present invention includes a controller 110 that is in communication with one or more retailers 115 via a network such as the Internet (wired and/or wirelessly), via another network protocol, or via other means for communication as would be understood by those of ordinary skill in the art. Although only one retailer 115 is depicted in FIG. 1A, any number of retailers may be in communication with the controller 110.

The controller 110 also communicates with a customer 105 via a network such as the Internet (wired and/or wirelessly), via another network protocol, or via other means for communication as would be understood by those of ordinary skill in the art. Although only one customer 105 is depicted in FIG. 1A, any number of customers may be in communication with the controller 110.

The customer 105 and/or retailer 115 may comprise computers, such as those based on the Intel® Pentium® processor, that are adapted to communicate with the controller 110.

Communication with the controller 110 may be direct or indirect. For example, communication may be via the Internet through a Web site maintained by controller 110 on a remote server or via an on-line data network including commercial on-line service providers, bulletin board systems and the like. In some embodiments, the customer 105 and retailer 115 may communicate with controller 110 over radio frequency (“RF”), infrared (“IR”), cable TV, satellite links and the like, including combinations thereof.

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet may not transmit data to the other device for weeks at a time.

The controller 110 may function as a “Web server” that generates Web pages (documents on the Web that typically include an HTML file and associated graphics and script files) that may be accessed via the Web and allows communication with the controller 110 in a manner known in the art. Those of skill in the art will understand that there are a variety of well-known ways for creating and operating Web pages, and accordingly a detailed description of such known processes is omitted here for clarity.

Any or all of the customer 105, the controller 110 and retailer 115 may comprise, e.g., a conventional personal computer, a portable type of computer, such as a laptop computer, a palm-top computer, a hand-held computer, or a Personal Digital Assistant (PDA), or combinations thereof.

Referring to FIG. 1B, an apparatus 130 according to an embodiment of the present invention includes a controller 140 that is in communication with one or more customer terminals 135, one or more manufacturers 142, one or more sponsors 145, and one or more credit card clearing houses 152. Communication with each may be via a network such as the Internet (wired and/or wirelessly), via another network protocol, or via other means for communication as would be understood by those of ordinary skill in the art. It is also possible that controller 140 will receive information directly or indirectly from a POS terminal 150, such as a cash register (e.g., mechanical or electronic). The POS terminal may include a bar code scanner, keypad, and/or any other input device for receiving information related to one or more products being acquired. The POS terminal may also comprise or include means for receiving the previously assigned redemption code, along with information related to the specific products having been taken delivery of (e.g. coded information such as bar codes, SKUs or other product descriptor(s)).

A customer 105 communicates with the customer terminal 135, which may include a web browser or other known user interface means. The customer 105 also communicates with the POS terminal 150. In typical situations, the customer 105 will not communicate with the customer terminal 135 and the POS terminal 150 simultaneously.

As is known in the art, the credit card clearinghouse 152 communicates with one or more banks 155 as well as with the one or more POS terminals 150 to effectuate the processing of transactions made using a credit card account. For example, the credit card clearinghouse 152 may receive from the POS terminal a request to authorize a purchase for which a credit card account is to be charged for payment. The credit card clearinghouse 152 in turn responds to the request, typically to either authorize or deny the request. Via communication with the credit card clearinghouse 152, the controller 140 may likewise effectuate processing of credit card transactions via its communication with the credit card clearinghouse 152.

The manufacturers 142 can communicate with the controller 140 to, e.g., communicate desired prices, promotions and other product and pricing information to controller. It will be understood by those of ordinary skill in the art that, in addition to manufacturers, other product suppliers or sellers such as retailers, wholesalers and the like may communicate in a like manner with the controller 140.

The sponsors 145 include merchants willing to provide a benefit to the controller, manufacturer, customer, retailer and/or other parties in exchange for, e.g., advertising to the customer, acquisition of the customer as a client of the sponsor, other interaction with the customer.

Referring to FIG. 1C, an apparatus 160 according to an embodiment of the present invention includes a controller 165 that is in communication with one or more customer terminals 135, one or more manufacturers 142, one or more sponsors 145, and one or more credit card clearing houses 152. Communication with each may be via a network such as the Internet (wired an/or wirelessly), via another network protocol, or via other means for communication as would be understood by those of ordinary skill in the art.

It is also possible that controller 165 will receive information directly or indirectly from a POS terminal 170, via a POS peripheral 175 and a peripheral server 180. The POS terminal 170 may be a cash register (e.g., mechanical or electronic). The POS peripheral 175 may be a device that receives information from the POS terminal 170, such as a coupon printer of the type manufactured by Catalina Marketing Corporation. The peripheral server 180 may be in communication with a plurality of such POS peripherals, thereby allowing the peripheral server 180 to receive information regarding a plurality of transactions at a plurality of retailers.

The POS peripheral 175 may be operable to access a database (e.g., of peripheral server 180) to issue custom coupons, offers, incentives and messages based upon the transaction. The peripheral server 180 may thus monitor shopper purchase history over time by associating purchase behavior with customer identifiers, such as loyalty card or check cashing card numbers. Further, this information may be analyzed, e.g., to identify those customers which a particular retailer should find most desirable. Based upon retailer objectives, the peripheral server 180 may direct the appropriate POS peripheral 175 to issue customized messages to specific shoppers that are relevant to their shopping behaviors.

Information received by the POS peripheral 175 from the POS terminal 170 may include transaction data such as products purchased, prices of products purchased, coupons redeemed, and time and date of transaction.

A customer 105 communicates with the customer terminal 135, which may include a web browser or other known user interface means. The customer 105 also communicates with the POS terminal 170. In typical situations, the customer 105 will not communicate with the customer terminal 135 and the POS terminal 150 simultaneously.

As is known in the art, the credit card clearinghouse 152 communicates with one or more banks 155 as well as with the one or more POS terminals 150 to effectuate the processing of transactions made using a credit card account. For example, the credit card clearinghouse 152 may receive from the POS terminal a request to authorize a purchase for which a credit card account is to be charged for payment. The credit card clearinghouse 152 in turn responds to the request, typically to either authorize or deny the request. Via communication with the credit card clearinghouse 152, the controller 165 may likewise effectuate processing of credit card transactions via its communication with the credit card clearinghouse 152.

The manufacturers 142 can communicate with the controller 165 to, e.g., communicate desired prices, promotions and other product and pricing information to controller. It will be understood by those of ordinary skill in the art that, in addition to manufacturers, other product suppliers or sellers such as retailers, wholesalers and the like may communicate in a like manner with the controller 165.

The sponsors 145 include merchants willing to provide a benefit to the controller, manufacturer, customer, retailer and/or other parties in exchange for, e.g., advertising to the customer, acquisition of the customer as a client of the sponsor, other interaction with the customer.

In addition to the description above, other means for the controller to receive information regarding a set of products for which a buyer price is established online, and a corresponding set of products picked up at the retailer.

Devices

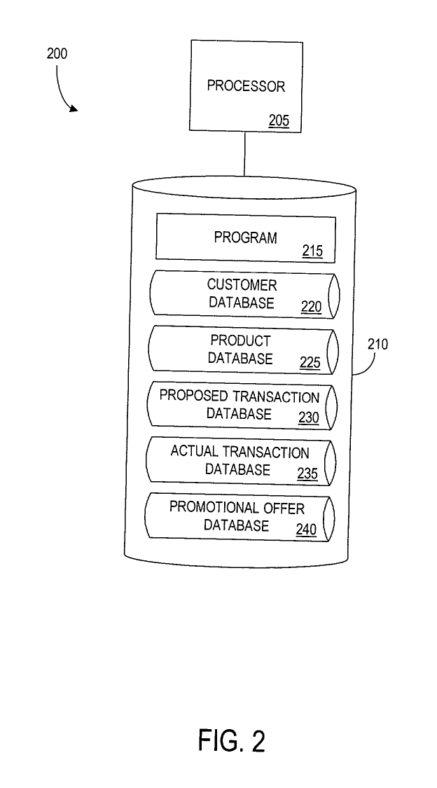

FIG. 2 illustrates an embodiment 200 of a controller. The controller may be implemented as a system controller, a dedicated hardware circuit, an appropriately programmed general purpose computer, or any other equivalent electronic, mechanical or electro-mechanical device.

The controller 200 comprises a processor 205, such as one or more Intel® Pentium® processors. As is well known in the art, the processor 205 may be in communication with a communication port (not shown in FIG. 2) or other means for facilitating communication between the processor 205 and other devices.

The processor 205 is also in communication with a data storage device 210. The data storage device 210 comprises an appropriate combination of magnetic, optical and/or semiconductor memory, and may include, for example, Random Access Memory (RAM), Read-Only Memory (ROM), a compact disc and/or a hard disk. The processor 205 and the storage device 210 may each be, for example: (i) located entirely within a single computer or other computing device; or (ii) connected to each other by a remote communication medium, such as a serial port cable, telephone line or radio frequency transceiver or other wired or wireless media. In one embodiment, the controller may comprise one or more computers that are connected to a remote server computer for maintaining databases.

The data storage device 210 stores a program 215 for controlling the processor 205. The processor 205 performs instructions of the program 215, and thereby operates in accordance with the embodiments of the present invention, and particularly in accordance with the methods described in detail herein. The program 215 may be stored in a compressed, uncompiled and/or encrypted format. The program 215 furthermore includes program elements that may be necessary, such as an operating system, a database management system and “device drivers” for allowing the processor 205 to interface with computer peripheral devices. Appropriate program elements are well known to those of ordinary skill in the art, and need not be described in detail herein.

According to an embodiment of the present invention, the instructions of the program 215 may be read into a main memory from another computer-readable medium, such from a ROM to RAM. Execution of sequences of the instructions in program 215 causes processor 205 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

The storage device 210 also stores (i) a customer database 220, (ii) a product database 225, (iii) a proposed transaction database 230, (iv) an actual transaction database 235 and (v) a promotional offer database 240. The databases are described in detail below and depicted with exemplary entries in the accompanying figures. As will be understood by those skilled in the art, the schematic illustrations and accompanying descriptions of the databases presented herein are exemplary arrangements for stored representations of information. Many other arrangements may be employed besides those suggested by the tables shown. Similarly, the illustrated entries of the databases represent exemplary information only; those skilled in the art will understand that the number and content of the entries can be different from those illustrated herein.

Databases

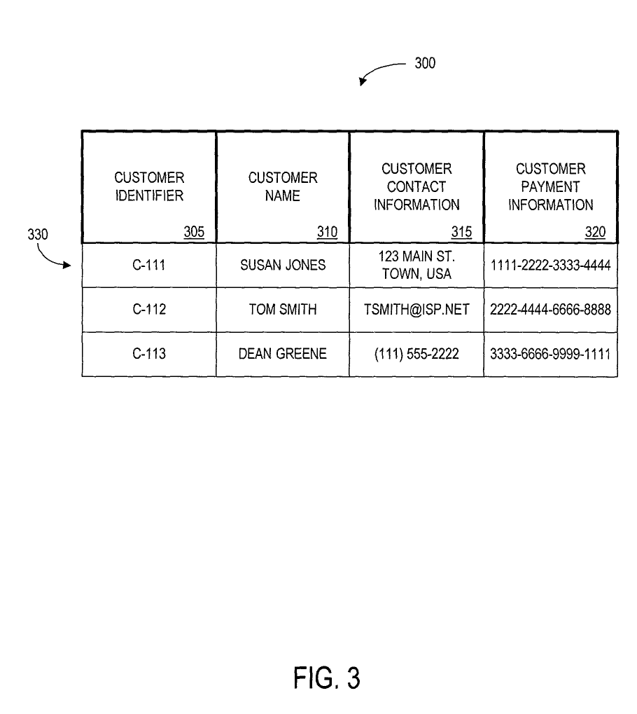

FIG. 3 is a tabular representation of an embodiment 300 of the customer database. The tabular representation of the customer database includes a number of example records or entries, including the entry 330, each of which defines a customer. Those skilled in the art will understand that the customer database may include any number of entries. The tabular representation of customer database also defines fields for each of the entries or records. The fields specify: (i) a customer identifier 305 that uniquely identifies the customer; (ii) a customer name 310; (iii) contact information 315 of the customer; and (iv) payment information 320 of the customer, such as credit card or debit card account information which may be used to render payment on behalf of the customer.

The customer identifier, as well as other identifiers described herein, may be generated or assigned by the controller, or may be established by the customer and provided to the controller by way of a customer terminal or other appropriate device. For example, the customer identifier may comprise a numeric code that is assigned to the corresponding customer by the controller. Alternatively, the customer identifier may comprise a user name and/or password that may be generated by a customer terminal and subsequently provided to the controller.

The data stored in the contact information field may comprise any of (i) an electronic mail (e-mail) address, (ii) a postal address, (iii) telephone number, and (iv) a numeric IP address of the customer.

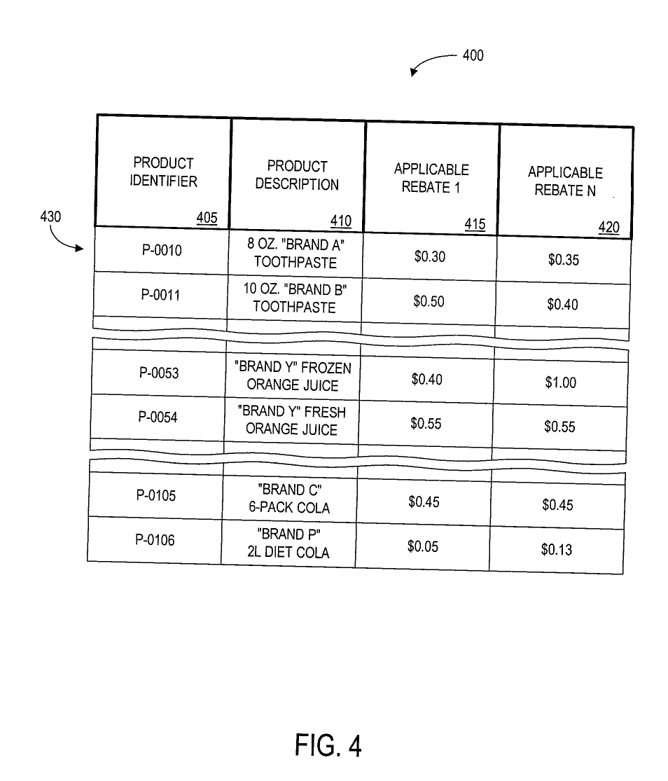

FIG. 4 is a tabular representation of an embodiment 400 of the product database. The tabular representation of the product database includes a number of example records or entries, including the entry 430, each of which defines a product offered for sale. Those skilled in the art will understand that the product database may include any number of entries, and that the information stored thereby may be specific to particular retailers. For example, the entry 430 may indicate a product offered for sale by, e.g., only a certain chain of stores, but not by others. Accordingly, the entries may optionally be associated with a retailer or set of retailers.

The tabular representation of product database also defines fields for each of the entries or records. The fields specify: (i) a product identifier 405 that uniquely identifies the product, such as an SKU or other appropriate identifier; (ii) a product description 410; and (iii) applicable rebates 415 and 420. Although two applicable rebates are illustrated in FIG. 4, any number of rebates may be used, and the number of rebates may differ among products in any manner desired.

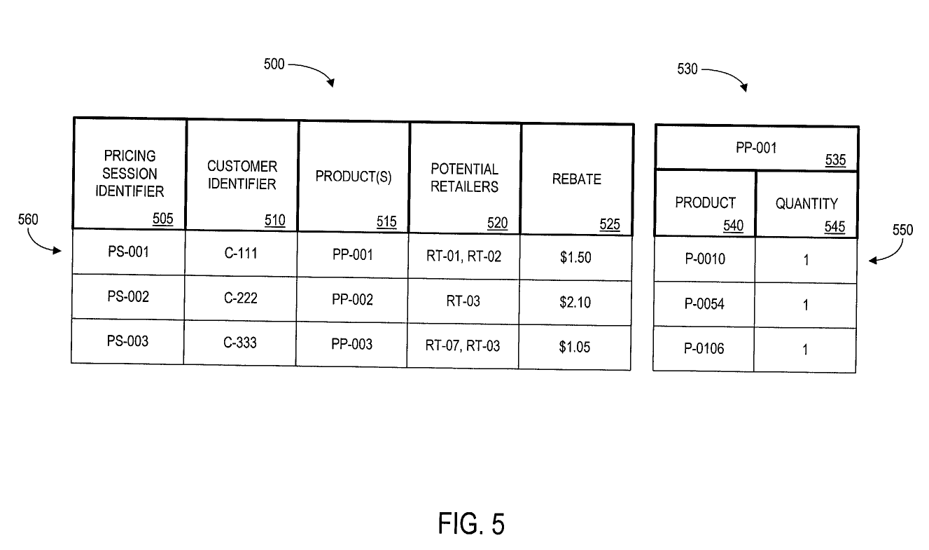

FIG. 5 is a tabular representation of an embodiment 500 of the proposed transaction database. The tabular representation of the proposed transaction database includes a number of example records or entries, including the entry 560, each of which defines a proposed transaction in which a customer agrees to purchase one or more products. Those skilled in the art will understand that the proposed transaction database may include any number of entries.

The tabular representation of proposed transaction database also defines fields for each of the entries or records. The fields specify: (i) a pricing session identifier 505 that uniquely identifies the proposed transaction; (ii) a customer identifier 510 that identifies the customer agreeing to the proposed transaction; (iii) one or more products 515 which the customer agrees to purchase; (iv) potential retailers 520 at which the customer may pickup or otherwise acquire the products; (v) a rebate 525 which the customer receives.

The pricing session identifier may merely be the customer identifier. In such an embodiment, the customer identifier serves to identify the proposed transaction.

The products field 515 refers to one or more products, represented by the table 530. The table 530 indicates a unique products identifier 535 which corresponds to an entry of the products field 515. The table 530 further defines one or more entries, each entry defining a product 540 and a quantity 545. for example, the entry 550 indicates a product “P-0010” and a quantity of “1”.

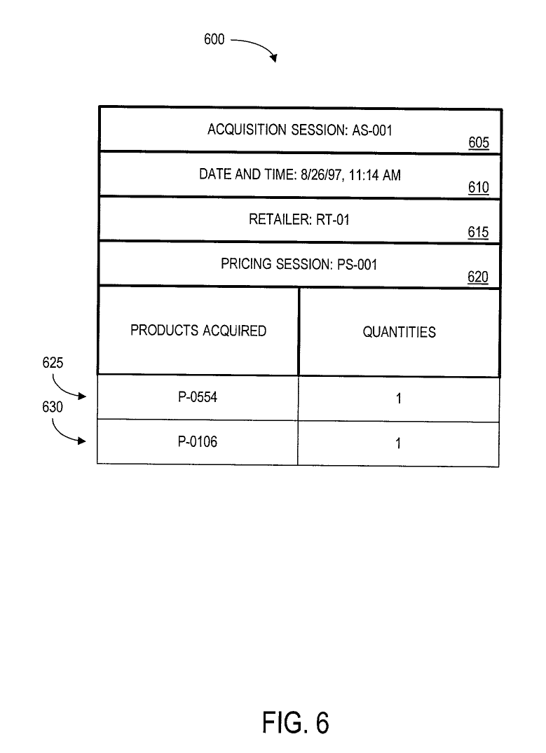

FIG. 6 is a tabular representation of a record 600 of an embodiment of the actual transaction database. The actual transaction database would typically contain a plurality of such records, each such record defining an actual transaction of a customer with a retailer. The tabular representation of the record 600 includes a number of example records or entries, including the entries 625 and 630, each of which defines a product and corresponding quantity acquired during the transaction. Those skilled in the art will understand that the record may include any number of entries. The tabular representation of customer database also defines fields for each of the entries or records.

The record further specifies: (i) an acquisition session identifier 605 that uniquely identifies the actual transaction; (ii) a date and time 610 of the transaction; (iii) a retailer 615 with which the transaction occurred; and (iv) a pricing session 620 which indicates the proposed transaction that the actual transaction was purported to correspond to.

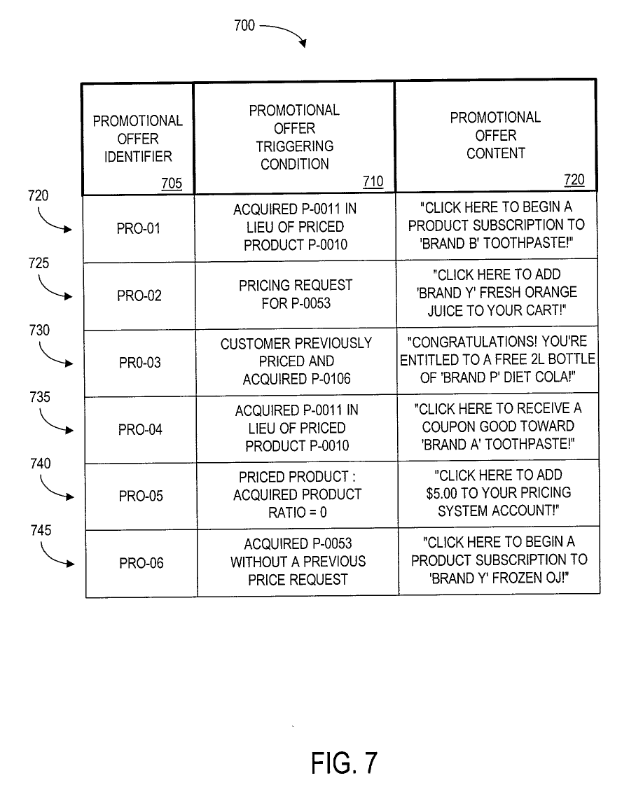

FIG. 7 is a tabular representation of an embodiment 700 of the promotional offer database. The tabular representation of the promotional offer database includes a number of example records or entries 720, 725, 730, 735, 740 and 745, each of which defines a possible promotion. Those skilled in the art will understand that the promotional offer database may include any number of entries. The tabular representation of promotional offer database also defines fields for each of the entries or records. The fields specify: (i) a promotional offer identifier 705 that uniquely identifies the possible promotion; (ii) a triggering condition 610 defining when the offer may be provided; and (iii) promotional offer content 615 describing the promotion.

Process Description

In accordance with the present invention, the controller may determine a first plurality of products which a buyer has agreed to purchase in exchange for a rebate or other favorable treatment. The agreement may be to purchase the products for a buyer price that is lower than a retail price of the first plurality of products.

Thereafter, the controller determines a second plurality of products which the buyer has actually received, e.g., by receiving from a retailer the transaction log indicating transactions with the retailer. The controller may then output a promotional offer during a subsequent interaction with the customer, such as when the customer logs on to a web site to price additional products and/or agree to purchase such products. The promotional offer is based on a difference between the first plurality of products and the second plurality of products.

For example, the controller may determine that the second plurality of products includes a particular product, but the first plurality of products does not include the product. The controller may, according to one embodiment, output a promotional offer which is based on that product.

In another embodiment, the controller may determine that the second plurality of products includes a particular product, but the first plurality of products does not include the product. However, the first plurality of products includes a substitute of that product. The controller may, according to one embodiment, output a promotional offer which is based on that product or the substitute.

Promotional offers may also be based on a product included in the first plurality of products. Promotional offers may also be based on a product that is included in both the first and second plurality of products. Promotional offers may also be based on the fact that the second plurality of products does not include any product included in the first plurality of products.

Promotional offers may also be based on a third plurality of products which are included in the second plurality of products, but are not included in the first plurality of products.

In each of the embodiments, promotional offers may be more specifically based on the value, cost, etc of the products.

Further, a promotional offer may comprise an offer for an additional product, an offer for a discount on a product, an offer for a subscription to a product, and an offer for a subscription to a product. Other offers will be readily understood by those of skill in the art.

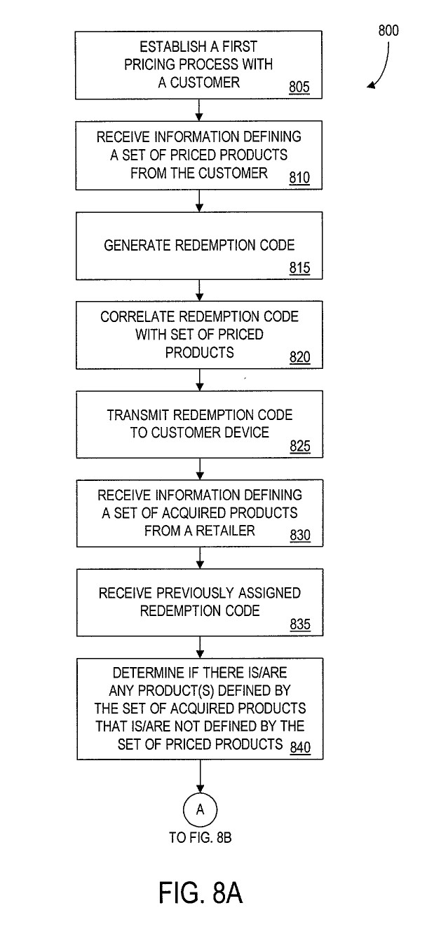

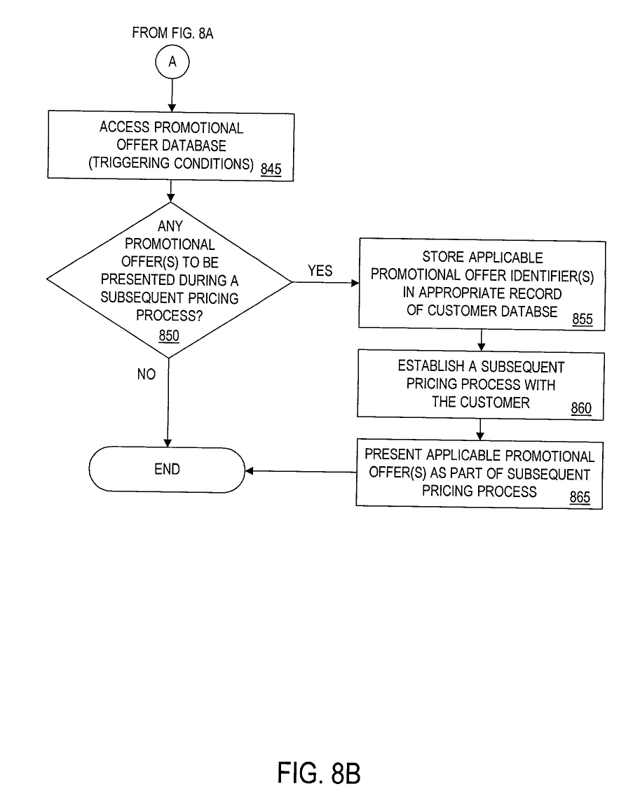

Referring to FIGS. 8A and 8B, a flowchart 800 represents an embodiment of the present invention that may be performed by the controller. The particular arrangement of elements in the flow chart of FIGS. 8A and 8B, as well as the other flow charts discussed herein, is not meant to imply a fixed order to the steps; embodiments of the present invention can be practiced in any order that is practicable.

At step 805, the controller establishes a first pricing process with a customer. As discussed herein, the on-line pricing system of the present invention may be embodied as one or more Web server(s) operating to host a Web site. Thus a first pricing process may be established by way of receiving a “log on” signal from a customer device, such as a personal computer, PDA, wireless application protocol (WAP) enabled telephone, or the like.

According to one embodiment of the present invention, the on-line pricing system may comprise or include an interactive voice response unit (IVRU), such as the ML5250, manufactured by MISSING LINK, Inc. According to this embodiment, the first pricing process may be established by way of the on-line pricing system apparatus establishing telephone-based communication with the customer device.

At step 805, the controller receives information defining a set of priced products from the customer. Where the on-line pricing system comprises or includes a Web Server, information defining a first set of priced products may be received for example, by receiving one or more inputs generated by the customer device. Such inputs may include requests for presentation of certain Web pages, navigational inputs such as “click-throughs”, product selection signals, etc.

Where the on-line pricing system comprises or includes an IVRU, information defining a set of priced products may be received via one or more dual tone multi-frequency signal(s) generated by the customer device in response to audible signals transmitted thereto.

As discussed above, in accordance with some embodiments of the present invention, products may be “priced” by the on-line pricing system apparatus by way of calculating a retail price associated with one or more products, less any applicable rebate(s) associated with those products.

According to other embodiments of the present invention, products may be priced by the on-line pricing system apparatus by receiving information representing an offer or bid price from the customer device, as described above herein. According to these embodiments, products may be priced either individually, or aggregately. For example, a customer may provide offers for each of a plurality of products individually, or may provide an offer including an offer price for a group of products (e.g. a basket of groceries).

At step 815, the controller generates a redemption code, as described in the patent applications referred to previously.

At step 820, the controller correlates the redemption code with set of priced products. The redemption code may be correlated to a specific set of priced products by way of the pricing session database. More specifically, the redemption code may be stored in a database record correlatively related to information representing a specific customer as well as one or more priced product(s).

At step 825, the controller transmits the redemption code to customer terminal. According to various embodiments, the on-line pricing system apparatus may generate a redemption code, thereby entitling the customer to one or more previously negotiated prices. More specifically, the redemption code may be transmitted to the customer device from the on-line pricing system. Thereafter, the customer may provide the redemption code to the retailer (i.e. retailer system) from which the customer elects to take delivery of one or more previously priced product(s).

Following receipt of the redemption code by the retailer system, the retailer may transmit or otherwise make available the redemption code back to the on-line pricing system apparatus, as will be discussed below.

At step 830, the controller receives information defining a set of acquired products from a retailer. The on-line pricing system may receive information defining a set of products having been acquired by a customer from a retailer. The information defining the set of acquired products may be received from a retailer system in conjunction with a previously issued redemption code. Thereafter, the information may be stored in an appropriate record of the acquired product(s) database.

At step 835, the controller receives a previously assigned redemption code. The on-line pricing system apparatus may receive a previously issued/assigned redemption code from a retailer system in conjunction with information defining a set of products having been acquired by a customer from the retailer. In this manner, the on-line pricing system receives and stores information defining a set of priced products and a set of acquired products. Each set of received information may be correlatively related by way the redemption code.

At step 840, the controller determines if there is any product(s) defined by the set of acquired products that is not defined by the set of priced products. The on-line pricing system may compare information defining a set of priced products to information representing a set of acquired products. Based on any differential between the two sets of information, the on-line pricing system apparatus may then determine the applicability of one or more promotional offers to be presented to a customer as part of a subsequent pricing process in a manner described immediately below.

At step 845, the controller accesses the promotional offer database, and at step 850 determines if there is/are any promotional offer(s) to be presented to the customer during a subsequent pricing process. By comparing information defining a set of priced products to information representing a set of acquired products, the on-line pricing system apparatus may determine the applicability of one or more promotional offer(s) to be presented to a customer as part of a subsequent pricing process. More specifically, the on-line pricing system apparatus may compare the differential (if any) between a set of priced products and a set of acquired products to information representing one or more promotional offer triggering conditions, in order to establish the applicability of one or more promotional offers.

At step 855, if promotional offer(s) is/are to be presented to the customer during a subsequent pricing process, the controller stores applicable promotional offer identifier(s) in association with the customer. According to some embodiments of the present invention, any promotional offers deemed to be applicable by the on-line pricing system apparatus may be indicated by way of storing one or more applicable promotional offer identifier(s), possibly in an appropriate record of the customer database or otherwise in association with the customer. The applicability of one or more promotional offer(s) may be determined by comparing the differential between a set of priced products and a set of acquired products to the information represented in the promotional offer triggering condition(s) field of the promotional offer database. Thereafter, any promotional offer deemed to be applicable may be stored in the applicable promotional offer identifier(s) field of the customer database. It should be appreciated that promotional offers may merely be selected from a database, or generated by the controller, or a combination thereof.

Upon establishing a subsequent pricing process with the customer defined by an entry in the customer database, the on-line pricing system apparatus may retrieve the applicable promotional offer identifier(s) from the appropriate field and record of the customer database in order to present the appropriate promotional offer(s) to the customer.

At step 860, the controller establishes a subsequent pricing process with the customer. During the subsequent pricing process, any offer(s) previously deemed to be presentable to the customer (e.g., based on the differential between one or more previously priced product(s) and one or more product(s) ultimately taken delivery of) may be presented. For example, the offer may be output from by the on-line pricing apparatus to the customer device by way of a Web page and/or audible signal for customer acceptance or decline.

At step 865, the controller outputs applicable promotional offer(s) as part of the subsequent pricing process. Upon establishing a subsequent pricing process with the customer defined by an entry in the customer database, the on-line pricing system apparatus may retrieve the applicable promotional offer identifier(s) from the appropriate field and record of the customer database in order to present the appropriate promotional offer(s) to the customer. More specifically, the information retrieved from the applicable promotional offer(s) field of the customer database may be used to retrieve the appropriate offer content from the promotional offers database. Thereafter, the appropriate promotional offer content may be output to the customer. For example, the offer content may be represented as text or audio on a Web site, or may be output as an audible prompt for acceptance or decline by the customer, via a telephonic communications (e.g. where the on-line pricing system includes an IVRU).

The following are several examples which illustrate additional embodiments of the present invention. These examples do not constitute a definition of all possible embodiments, and those skilled in the art will understand that the present invention is applicable to many other embodiments. Further, although the following examples are briefly described for clarity, those skilled in the art will understand how to make any changes, if necessary, to the above-described apparatus and methods to accommodate these and other embodiments and applications.

Although the present invention has been described with respect to a preferred embodiment thereof, those skilled in the art will note that various substitutions may be made to those embodiments described herein without departing from the spirit and scope of the present invention.

For example, products may be priced by way of receiving information from a customer device defining a group of products (or types of products) the customer is willing to purchase. Thereafter, the on-line pricing system apparatus may generate a product list based on the received information and calculate a rebate amount due to the customer.

Products may also be priced by the on-line pricing system apparatus by way of receiving information defining a group of products (or types of products) the customer is willing to purchase, the information further including a buyer-defined price. According to this embodiment, the buyer-defined price may be associated with either individual products and/or a group of products.

A transaction “tagging” process may be used to correlate on-line pricing negotiations with transactions during which consumers take delivery of products from a physical store. The tagging process may include issuing a redemption code to the customer as part of the on-line pricing process. The redemption code may then be presented to the retailer by the customer when taking delivery of one or more products. The retailer may then communicate the redemption code, along with information defining a set of products that the customer took delivery of, back to the on-line pricing system.

Certain products or types of products may fall outside of a quantifiable differential. For example, a consumer having contracted prices for milk, eggs and bread may subsequently take delivery of products including the milk, eggs, bread and ½ doz. oranges. The purchase of oranges in addition to the previously priced products may be the result of the consumer not having decided to purchase the oranges until having actually seen them in the physical store.

Thus the system may make certain concessions as to which products are and are not to be included when establishing the differential between products priced on-line and products having been acquired. For example, the system may recognize “produce” as a type of product not to be included as the subject of a promotional offer during a subsequent pricing process.

What is claimed is:

1. A method comprising:
establishing online a buyer price for a first plurality of products, the buyer price being lower than a retail price of the first plurality of products, the first plurality of products to be picked up during a subsequent transaction at a retailer;
determining a second plurality of products which the buyer has actually received during the subsequent transaction;
determining that the second plurality of products includes a product,
determining that the first plurality of products does not include the product; and
outputting a promotional offer during a subsequent interaction with the customer,
in which the promotional offer is based on the product.

2. A method comprising:
establishing online a buyer price for a first plurality of products, the buyer price being lower than a retail price of the first plurality of products, the first plurality of products to be picked up during a subsequent transaction at a retailer;
determining a second plurality of products which the buyer has actually received during the subsequent transaction;
determining that the second plurality of products includes a product,
determining that the first plurality of products does not include the product, and
determining that the first plurality of products includes a substitute of the product;
determining that the second plurality of products does not include the substitute of the product; and
outputting a promotional offer during a subsequent interaction with the customer,
in which the promotional offer is based on at least one of the product and
the substitute of the product.

3. A method comprising:
establishing online a buyer price for a first plurality of products, the buyer price being lower than a retail price of the first plurality of products, the first plurality of products to be picked up during a subsequent transaction at a retailer;
determining a second plurality of products which the buyer has actually received during the subsequent transaction;
determining a product which the first plurality of products includes; and
outputting a promotional offer during a subsequent interaction with the customer,
in which the promotional offer is based on the product.

4. A method comprising:
establishing online a buyer price for a first plurality of products, the buyer price being lower than a retail price of the first plurality of products, the first plurality of products to be picked up during a subsequent transaction at a retailer;
determining a second plurality of products which the buyer has actually received during the subsequent transaction;
determining that the second plurality of products includes a product,
determining that the first plurality of products includes the product; and
outputting a promotional offer during a subsequent interaction with the customer,
in which the promotional offer is based on the product.

5. A method comprising:
establishing online a buyer price for a first plurality of products, the buyer price being lower than a retail price of the first plurality of products, the first plurality of products to be picked up during a subsequent transaction at a retailer;
determining a second plurality of products which the buyer has actually received during the subsequent transaction;
determining that the second plurality of products does not include any product included in the first plurality of products; and
outputting a promotional offer during a subsequent interaction with the customer.

6. A method comprising:
establishing online a buyer price for a first plurality of products, the buyer price being lower than a retail price of the first plurality of products, the first plurality of products to be picked up during a subsequent transaction at a retailer;
determining a second plurality of products which the buyer has actually received during the subsequent transaction;
determining a third plurality of products which are included in the second plurality of products, but are not included in the first plurality of products;
determining a value of the third plurality of products; and
outputting a promotional offer during a subsequent interaction with the customer,
in which the promotional offer is based on the third plurality of products.

7. A method comprising:
determining a first plurality of products which a buyer has agreed to purchase in exchange for a rebate;
determining a second plurality of products which the buyer has actually received;
determining a promotional offer based on a difference between the first plurality of products and the second plurality of products; and
outputting the promotional offer during a subsequent interaction with the customer.

8. The method of claim 7, in which
the promotional offer comprises an offer for an additional product.

9. The method of claim 7, in which
the promotional offer comprises an offer for a discount on a product.

10. The method of claim 7, in which:
the promotional offer comprises an offer for a subscription to a product.

11. The method of claim 7, in which
the promotional offer comprises an offer for a subscription to a product.

12. The method of claim 7, in which the step of determining a promotional offer comprises:
selecting the promotional offer from a plurality of promotional offers based on the difference between the first plurality of products and the second plurality of products.

13. The method of claim 7, in which the step of determining a promotional offer comprises:
generating the promotional offer based on the difference between the first plurality of products and the second plurality of products.

14. The method of claim 7, in which the step of determining a promotional offer comprises:
retrieving a promotional offer from a storage medium.
